(19) United States
(12) Patent Application Publication
(10) Pub. No.: US 2026/0333366 A1
(43) Pub. Date: Oct. 22, 2026

(54) LINK RANDOM ACCESS METHOD AND DEVICE

(71) Applicant: CHINA SATELLITE NETWORK INNOVATION CO., LTD, Beijing (CN)

(72) Inventors: Rui TENG, Beijing (CN); Yingying WANG, Beijing (CN); Chunlei NIU, Beijing (CN); Ying ZHAO, Beijing (CN); Junshuai SUN, Beijing (CN)

(21) Appl. No.: 19/540,415

(22) Filed: Feb. 13, 2026

Related U.S. Application Data
(63) Continuation of application No. PCT/CN2025/123386, filed on Sep. 23, 2025.

(30) Foreign Application Priority Data
Apr. 21, 2025 (CN) 202510502700.9

(51) Int. Cl. H04W 72/23; H04W 74/00

(52) U.S. Cl. CPC H04W 72/23; H04W 74/002; H04W 74/004

(57) ABSTRACT

A link random access method including: receiving, on a unified physical layer of the base station, a random access request transmitted from at least one terminal on a random access resource corresponding to a terminal type to which the at least one terminal belongs; determining, by the unified physical layer, an MAC entity and transmitting the random access request to the determined MAC entity; and transmitting, to the at least one terminal, a random access response corresponding to the random access request, wherein the random access response is generated by the determined MAC entity.

### CROSS-REFERENCE TO RELATED APPLICATIONS

The present application is a continuation under U.S.C. §111(a) of International Patent Application No. PCT/CN2025/123386, filed on Sep. 23, 2025, which claims priority to Chinese Patent Application No. 202510502700.9, entitled "Link Random Access Method and Device" and filed on Apr. 21, 2025, both of which are hereby incorporated by reference in their entireties.

### TECHNICAL FIELD

The present application pertains to the technical field of satellite communications, in particular to a link random access method and device.

### BACKGROUND

As shown in FIG. 1, it is a schematic diagram of an existing satellite communication architecture. The transmission between a user and a satellite-based base station is a satellite-ground transmission based on a service link, the transmission between the satellite-based base station and a ground gateway station is a satellite-ground transmission based on a feeder link, and the transmission between satellites is an inter-satellite transmission based on an inter-satellite link. Currently, the service link uses a wireless air interface (Uu interface) transmission, the feeder link uses a wireless air interface or microwave transmission, and the inter-satellite link uses laser or terahertz transmission.

Since the communication systems used for the three types of links, namely, the inter-satellite link, service link and satellite-ground link, are different, different transmission systems need to be set up on the satellite, and thus independent satellite payloads need to be designed. The current inter-satellite communications adopt laser communication without considering the scenarios where companion satellites exist. If all inter-satellite communications adopt the laser communication method, the number of laser communication payloads on the satellite will inevitably increase.

An effective solution has not yet been proposed for realizing flexible satellite-ground transmission and inter-satellite transmission without increasing the number of payloads.

### SUMMARY

An object of the present application is to provide a link random access method and device that can enable flexible satellite-ground transmission and inter-satellite transmission without increasing the number of payloads.

The link random access method and device provided by the present application are implemented as follows:

A link random access method, applied to a base station, including:
receiving, on a unified physical layer of the base station, a random access request transmitted from at least one terminal on a random access resource corresponding to a terminal type to which the at least one terminal belongs;
determining, by the unified physical layer, an MAC entity and transmitting the random access request to the determined MAC entity; and
transmitting, to the at least one terminal, a random access response corresponding to the random access request, wherein the random access response is generated by the determined MAC entity.

A link random access method, applied to a terminal, including:
transmitting a random access request to a base station on a random access resource corresponding to a terminal type to which the terminal belongs; and
receiving a random access response corresponding to the random access request transmitted from the base station, wherein the random access response carries an uplink grant.

A base station device, including a processor and a memory for storing instructions executable by the processor, wherein the processor implements steps of a method as described above.

A terminal device, including a processor and a memory for storing instructions executable by the processor, wherein the processor, when executing the instruction, implements steps of a method as described above.

A computer readable storage medium storing thereon computer programs/instructions which, when executed by a processor, implement a method as described above.

### BRIEF DESCRIPTION OF DRAWINGS

In order to more clearly explain the technical solutions in the embodiments of the present application or in the prior art, a brief introduction to the drawings needed in the descriptions of the embodiments or the prior art will be given below. Obviously, the drawings described below are only some embodiments of the present application, and a person of ordinary skill in the art may also obtain other drawings based on these drawings without making any creative efforts.

FIG. 1 is a schematic diagram of an existing satellite communication architecture;

FIG. 2 is an interaction flowchart of a link random access method provided by the present application;

FIG. 3 is a schematic diagram of the protocol layers for spatial link integration provided by the present application;

FIG. 4 is a schematic diagram of a user plane protocol architecture of a regenerative architecture after an integrated design is adopted provided by the present application;

FIG. 5 is a schematic diagram of a signaling plane protocol architecture of a regenerative architecture after an integrated design is adopted provided by the present application;

FIG. 6 is a schematic diagram of an inter-satellite link protocol architecture of a regenerative architecture after an integrated design is adopted provided by the present application;

FIG. 7 is a schematic diagram of a unified access procedure based on resource configuration provided by the present application;

FIG. 8 is a schematic diagram of a unified access procedure based on terminal-reported terminal type provided by the present application;

FIG. 9 is a block diagram of a hardware structure of an electronic device for a link random access method provided by the present application;

FIG. 10 is a schematic diagram of a module structure of an embodiment of a link random access device located in a base station provided by the present application; and

FIG. 11 is a schematic diagram of a module structure of an embodiment of a link random access device located in a terminal provided by the present application.

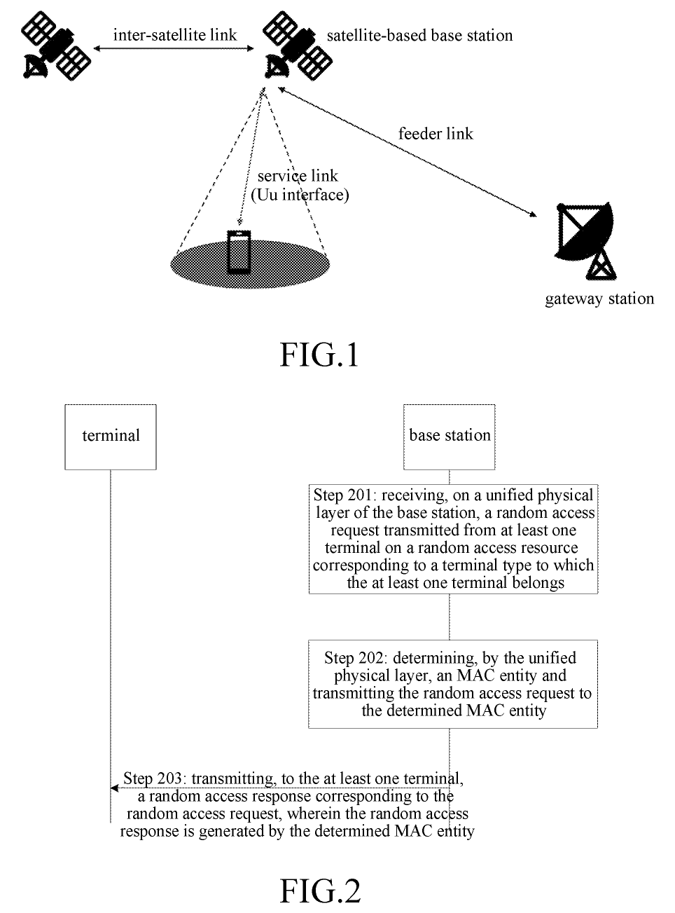

### DESCRIPTION OF EMBODIMENTS

In order to enable persons skilled in the art to better understand the technical solutions of the present application, clear and comprehensive descriptions of the technical solutions in the embodiments of the present application will be given in the following with reference to the drawings in the embodiments of the present application, but obviously, the embodiments described herein are only part of, rather than all of the embodiments of the present application. Based on the embodiments of the present application, all other embodiments obtained by persons with ordinary skills in the art without paying creative efforts shall pertain to the protection scope of the present application.

Referring to the drawings, through the following Description, the afore- mentioned and other features of the present application will become apparent. In the Description and the drawings, specific embodiments of the present application are disclosed, which indicate some embodiments that can adopt the principle of the present application. It should be understood that the present application is not limited to the described embodiments. On the contrary, the present application includes all modifications, variations and equivalents that fall within the scope of the attached claims.

In the embodiments of the present application, the terms "first", "second", and the like are used to distinguish different elements by name, but do not indicate a spatial arrangement or temporal sequence of these elements. These elements should not be restricted by these terms. The term "and/or" includes any one, and all combinations of one or more of the terms listed in association. The terms "contain", "comprise", "have", and the like refer to the existence of the stated features, elements, components or parts, but do not exclude the existence or addition of one or more other features, elements, components or parts.

In the embodiments of the present application, the singular forms "a", "this", and the like include the plural forms, and should be understood in a broad sense as "a kind" or "a type" rather than being limited to the meaning of "one". In addition, the term "said" should be understood to include both the singular and plural forms, unless otherwise explicitly specified in the context. In addition, the term "according to" should be understood as "at least partially according to...", and the term "based on" should be understood as "at least partially based on...", unless otherwise explicitly specified in the context.

In the embodiments of the present application, the term "communication network" or "wireless communication network" may refer to a network that conforms to any of the following communication standards, such as New Radio (NR), Long Term Evolution (LTE), enhanced Long Term evolution (LTE-A, LTE-Advanced), Wideband Code Division Multiple Access (WCDMA), High-Speed Packet Access (HSPA), etc.

Furthermore, the communication between devices in a communication system may be carried out according to a communication protocol at any stage, which for example may include, but is not limited to: 1G (generation), 2G, 2.5G, 2.75G, 3G, 4G, 4.5G, 5G, New Radio (NR), etc., and/or other communication protocols currently known or to be developed in the future.

In the embodiments of the present application, the term "network device", for example, refers to a device in the communication system that connects a terminal device to the communication network and provides services for the terminal device. The network device may include, but is not limited to: an integrated access and backhaul node (IAB-node), a base station (BS), an access point (AP), a transmission reception point (TRP), a broadcast transmitter, a mobile management entity (MME), a gateway, a server, a radio network controller (RNC), a base station controller (BSC), etc.

Here, the base station may include, but is not limited to: a node B (NB), an evolved node B (eNode B or eNB), a 5G base station (gNB), etc., and may also include a remote radio head (RRH), a remote radio unit (RRU), a relay, or a low power node (e.g., femeto, pico, etc.). The term "base station" may include some or all of the functions of these. Each base station can provide communication coverage for a specific geographical area. The term "cell" may refer to a base station and/or its coverage area, depending on the context.

In the embodiments of the present application, the term "user equipment" (UE) or "terminal device" (TE, or terminal device), for example, refers to a device that accesses a communication network through a network device and receives network services. The terminal device may be fixed or mobile, and may also be referred to as a mobile station (MS), a terminal, a subscriber station (SS), an access terminal (AT), a station, etc.

The terminal device may include, but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

In addition, the term "network side" or "network device side" refers to the side of the network, which may be a specific base station, or may include one or more of the network devices described above. The term "user side" or "terminal side" or "terminal device side" refers to the side of the user or the terminal, which may be a specific UE, or may also include one or more of the terminal devices described above.

In the embodiments of the present application, high-layer signaling may, for example, be Radio Resource Control (RRC) signaling; for instance, this may be referred to as an RRC message, such as an MIB, system information, and a dedicated RRC message, or it may be referred to as an RRC IE (RRC information element). The high-level signaling may also, for example, be MAC (Medium Access Control) signaling, which is also referred to as an MAC CE (MAC control element). However, the present application is not limited to these.

The following illustrates the scenarios of the embodiments of the present application by way of examples, but the present application is not limited thereto.

Currently, the transmission over a service link is carried out based on a wireless air interface (Uu interface), the transmission over a feeder link is carried out based on a wireless air interface or microwave, and the transmission over an inter-satellite link is carried out based on laser or terahertz. Since the communication systems used for these three types of links, namely, the inter-satellite link, service link and satellite-ground link, are different, different transmission systems need to be deployed on the satellite, and thus independent satellite payloads need to be designed, which will inevitably lead to an increase in the number of payloads.

On this basis, to simplify the inter-satellite link, service link and satellite-ground link, this application provides an integrated link transmission scheme, achieving flexible satellite-ground transmission and inter-satellite transmission by reusing the functions of the physical layer. To be specific, protocol functions and corresponding access procedures for a link-integrated scenario are proposed. Under the function of the unified physical layer, different protocol functions are designed for different links, and spatial link integration is achieved by adding link types. Therefore, unified access for the service link, satellite-ground link and inter-satellite link is achieved. To be specific, the provided protocol frame may include: a unified physical layer (general physical layer), a service link-oriented MAC layer (MAC-service link), a feeder link-oriented MAC layer (MAC-feeder link), an inter-satellite link-oriented MAC layer (MAC-inter-satellite link), and protocol layers above the MAC layers respectively corresponding to the service link, feeder link and inter-satellite link (the RLC and PDCP above the MAC-service link, and the general RRC).

The unified physical layer provides a unified waveform and frame structure, unified signal designs for synchronization, measurement, etc., unified uplink and downlink processing procedures, and unified random access mechanisms for the service link, feeder link and inter-satellite link. For example, all of the service link, feeder link and inter-satellite link may adopt a system frame structure with a length of 10ms and a subcarrier spacing of 15khz, 30khz or 120kz, etc., they all adopt the same primary and secondary synchronization signal design for synchronization; and they also use the same reference signals for measurement. In embodiments of this application, the design of the unified physical layer facilitates reusing the currently mature service link technology and extending the design of the service link to the feeder link and inter-satellite link. This can reduce the complexity of on-satellite payloads and further decrease their number.

For the service link-oriented MAC layer, the feeder link-oriented MAC layer and the inter-satellite link-oriented MAC layer, corresponding MAC layer protocols are respectively designed according to the characteristics and requirements of the service link, feeder link and inter-satellite link. For example, in a regenerative scenario, the service link is a link between a satellite-based base station and a terminal. The MAC layer protocol functions of the service link may include: providing the mapping between a logical link and a transmission link to the terminal, multiplexing and demultiplexing an MAC service data unit (SDU) in a transport block (TB), HARQ, scheduling (priority scheduling among different terminals, and priority scheduling among different logical channels in a same UE), etc. The feeder link is a link between a satellite and a gateway station. The main requirement for the feeder link is stable and reliable high-speed transmission. Based on this, the MAC layer protocol functions of the feeder link may include: multiplexing, demultiplexing, and HARQ functions. The feeder link may not have a scheduling function. The inter-satellite link is a link between satellites, which needs to ensure not only the reliability and stability of data transmission but also the fairness in data transmission between different inter-satellite links. Based on this, the MAC layer protocol functions of the inter-satellite link may include: multiplexing, demultiplexing, HARQ, and scheduling.

Furthermore, in order to realize unified control of the service link, feeder link and inter-satellite link, the unified radio resource control (RRC) may be adopted, which includes: the configuration of the service link, feeder link and inter-satellite link, and the unified allocation of user identifiers for various terminals.

The above-mentioned protocol scheme may be applied to a regenerative mode, and accordingly, the base station side equipment is a satellite-based base station. The above-mentioned protocol scheme may also be applied to a transparent mode, and accordingly, the base station side equipment is a ground base station.

Based on the above-mentioned protocol scheme, the embodiments of the present application provide a link random access method. FIG. 2 is a method flowchart of an embodiment of the link random access method provided by the present application. Although the present application provides the method operation steps or device structures described in the embodiments or shown in the drawings given below, more or fewer operation steps or module units may be included in the method or device based on conventional or non-creative efforts. In the steps or structures among which no necessary causal relationship exists logically, the execution sequence of these steps or the module structure of the device is not limited to the execution sequence or module structure described in the embodiments of the present application and shown in the attached figures. When applied in practice to a device or terminal product, the described method or module structure may be executed sequentially or in parallel in accordance with the method or module structure described in the embodiments or shown in the accompanying drawings (for example, in a parallel processor or a multi-threaded processing environment, or even in a distributed processing environment).

Specifically, as shown in FIG. 2, the above-described link random access method, applied to a base station, may include the following steps:

Step 201: receiving, on a unified physical layer of the base station, a random access request transmitted from at least one terminal on a random access resource corresponding to a terminal type to which the at least one terminal belongs;

Step 202: determining, by the unified physical layer, an MAC entity and transmitting the random access request to the determined MAC entity; and

Step 203: transmitting, to the at least one terminal, a random access response corresponding to the random access request, wherein the random access response is generated by the determined MAC entity.

The MAC entity may include at least one of: a service link-oriented MAC layer, an inter-satellite link-oriented MAC layer, or a feeder link-oriented MAC layer. That is, a unified physical layer is adopted, but different MAC layers are used, and different service links correspond to different MAC layers, so that unified link random access is achieved.

In implementation, the terminal type of the terminal side may include at least one of: a user terminal, a satellite access terminal, or a gateway station access terminal. To be specific, different terminal types may correspond to different MAC layers. For example, the user terminal corresponds to the service link-oriented MAC layer, the gateway station access terminal corresponds to the feeder link-oriented MAC layer, and the satellite access terminal corresponds to the inter-satellite link-oriented MAC layer.

For the link random access, the embodiments provide two unified access procedures: 1) Unified access procedure based on resource configuration:
At the software level, the above-described link random access device may be, as shown in FIG. 10, located in a base station, and includes:
a first receiving module 1001 configured to receive, on a unified physical layer of the base station, a random access request transmitted from at least one terminal on a random access resource corresponding to a terminal type to which the at least one terminal belongs;
a determining module 1002 communicating with the first receiving module 1001 and configured for the unified physical layer to determine an MAC entity and transmit the random access request to the determined MAC entity; and a first transmitting module 1003 communicating with the determining module 1002 and configured to transmit, to the at least one terminal, a random access response corresponding to the random access request, wherein the random access response is generated by the determined MAC entity.

Different random access resources are configured in system information for different types of access terminals, so that the terminals can perform random access using the corresponding access resources according to their own types. The physical layer determines the terminal type of the terminal side according to the random access resource where the received message is located, and then transmits a corresponding access request to the MAC entity corresponding to that link, thereby realizing the access procedure for the link.

For the base station, it may broadcast a system message to at least one terminal, where the system message indicates a correspondence between the terminal type and the random access resource. Correspondingly, the determining of an MAC entity includes: determining, by the unified physical layer, a terminal type to which the at least one terminal belongs according to the random access resource where the received random access request is located; determining, by the unified physical layer, a corresponding MAC entity according to the terminal type to which the at least one terminal belongs. The determined MAC entity negotiates with the unified RRC of the base station to obtain a cell-radio network temporary identifier allocated for the at least one terminal.

The system message may be SIB1, or may be SIB19, or may be a new system message SIB that is newly defined. Specifically, the random access resource may be a PRACH resource accessed by the UE.

Correspondingly, the base station side notifies the random access request to the selected MAC entity through the unified physical layer to complete the link random access, which may include:

S1: the base station side determines a terminal type to which the terminal side belongs through the unified physical layer according to the random access resource where the received random access request is located;

The random access resource may include, but is not limited to, at least one of: a time domain resource, a frequency domain resource, or a code domain resource.

S2: the base station side takes an MAC entity corresponding to the terminal type to which the terminal side belongs as a selected MAC entity;

S3: the base station side notifies the random access request to the selected MAC entity through the unified physical layer;

S4: the selected MAC entity negotiates with the unified RRC to obtain a cell-radio network temporary identifier allocated for the terminal side, and the selected MAC entity completes TA (Time Advance) estimation and UL (Uplink) resource granting.

That is, in the spatial integration access design, by introducing specific information or messages for different terminal types, the physical layer determines the terminal types through the specific information or messages, thereby utilizing the unified random access procedure. The specific information may be: specific frequency or time resources. Different access types are distinguished by distinguishing the random access resources in different time and frequency domains.

2) Unified access procedure based on terminals' reporting of terminal types:

In the random access process, different access terminal types are reported in the Msg3 message. The network selects MAC entities corresponding to the respective links for different terminals according to the terminal types reported by the terminal side, thereby realizing the access procedure for the links. Specifically, in the spatial link integration protocol design, for different terminal types, the Msg1 and Msg2 messages for random access can be completed following the existing procedures, without distinguishing the corresponding MAC protocol stacks. That is, for the Msg1 and Msg2 messages, the MAC entities can be randomly selected while exact matching is not required.

Correspondingly, the determining of an MAC entity by the base station may include: randomly selecting, by the unified physical layer, an MAC entity from one or more of the service link-oriented MAC layer, the inter-satellite link-oriented MAC layer, and the feeder link-oriented MAC layer as the determined MAC entity. The determined MAC entity allocates a cell-radio network temporary identifier for the at least one terminal; receives reporting information from the at least one terminal on an uplink granted resource, wherein the uplink granted resource is indicated by the random access response, and the reporting information carries a terminal type identifier of the at least one terminal; determines an MAC entity corresponding to the terminal type as a target MAC entity according to the terminal type identifier; notifies the cell-radio network temporary identifier to the target MAC entity through a unified RRC layer; and transmits a contention resolution response to the at least one terminal after scrambling a PDCCH using the cell-radio network temporary identifier.

Specifically, the base station side notifies the random access request to the selected MAC entity through the unified physical layer to complete the link random access, which may include:

S1: the base station side transmits the random access request to the selected MAC entity through the unified physical layer, wherein the selected MAC entity allocates the cell-radio network temporary identifier to the terminal side;

S2: the base station side returns a random access response to the terminal side;

S3: the base station side receives reporting information transmitted by the terminal side in accordance with the uplink granted resource in the random access response, wherein the reporting information carries a terminal type identifier of the terminal side;

S4: the base station side determines an MAC entity corresponding to the terminal type as a target MAC entity according to the terminal type identifier;

S5: the base station side notifies the cell-radio network temporary identifier to the target MAC entity through a unified RRC layer;

S6: the base station side transmits a contention resolution response to the terminal side after scrambling a PDCCH using the cell-radio network temporary identifier.

The reporting information may be RRC signaling, and the terminal type identifier is carried in a newly added identifier field within the RRC signaling. For example, using the RRC Setup Request message as the reporting message, the terminal type of the UE is identified by a newly added field named UE Type ID, which is 2 bits in size, to this message. When the flag bit indicates "0", it represents a traditional terminal such as ground mobile phone; when the flag bit indicates "1", it represents a feeder link terminal such as a gateway station; when the flag bit indicates "2", it represents an inter-satellite link terminal such as a companion satellite; when the flag bit indicates "3", it represents spare. In specific implementation, the reporting information may also be RRC signaling and an MAC CE, wherein the MAC CE is used to indicate the UE type identifier and specific information identifier.

In this example, also provided is a link random access method for a terminal side, which may include the following steps:

Step 1: transmitting a random access request to a base station on a random access resource corresponding to a terminal type to which the terminal side belongs; and

Step 2: receiving a random access response corresponding to the random access request transmitted from the base station, wherein the random access response carries an uplink grant.

The MAC entity may include, but is not limited to at least one of: a service link-oriented MAC layer, an inter-satellite link-oriented MAC layer, or a feeder link-oriented MAC layer. The terminal type to which the terminal belongs may include, but is not limited to at least one of: a user terminal, a satellite access terminal, or a gateway station access terminal.

For the terminal side, the terminal may transmit a random access request to the base station based on the random access resource corresponding to the terminal type to which the terminal belongs. Then, the terminal receives a random access response returned by the base station, where the random access response carries an uplink grant; the terminal selects a resource according to the uplink grant and transmits reporting information to the base station, where the reporting information carries a terminal type identifier of the terminal, where the terminal type identifier is used for the base station to determine an MAC entity.

In this way, flexible satellite-ground transmission and inter-satellite transmission are achieved without increasing the number of payloads.

In the following, the above method is described in conjunction with specific embodiments. However, it should be noted that this specific embodiment is provided merely to better illustrate the present application and does not constitute an undue limitation thereof.

To simplify the inter-satellite link, service link and satellite-ground link, these embodiments provide an integrated link transmission scheme, in which flexible satellite-ground transmission and inter-satellite transmission are achieved by reusing the function of the physical layer. To be specific, protocol functions and corresponding access procedures in the scenario of link integration are proposed. Under the function of the unified physical layer, different protocol functions are designed for different links, and spatial link integration is achieved by adding link types, thereby enabling unified access for the service link, satellite-ground link and inter-satellite link.

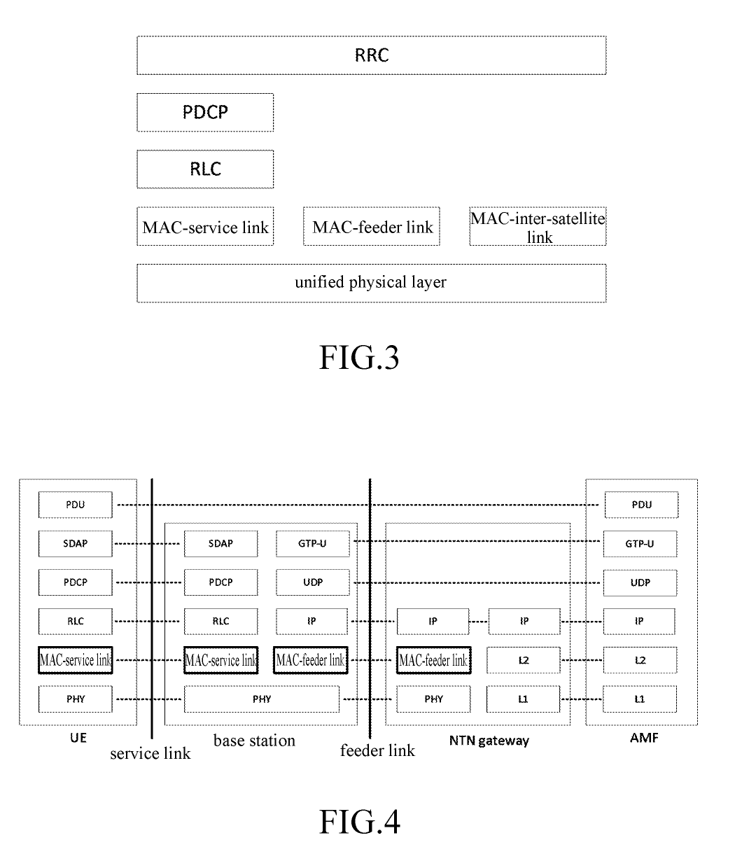

In this example, the protocol layer of spatial link integration is shown in FIG. 3, and may include: a unified physical layer (general physical layer), a service link-oriented MAC layer (MAC-service link), a feeder link-oriented MAC layer (MAC-feeder link), an inter-satellite link-oriented MAC layer (MAC-inter-satellite link), and protocol layers above the MAC layers respectively corresponding to the service link, feeder link and inter-satellite link (the RLC and PDCP above the MAC-service link, and the general RRC).

The unified physical layer provides a unified waveform and frame structure, unified signal designs for synchronization, measurement, etc., unified uplink and downlink processing procedures, and unified random access mechanisms for the service link, feeder link and inter-satellite link. For example, all the service link, feeder link and inter-satellite link may adopt a system frame structure of a length of 10ms with a subcarrier spacing of 15khz, 30khz or 120kz, etc., the same primary and secondary synchronization signal designs are adopted for synchronization, and they also use the same reference signals corresponding to measurement are adopted. In this example, the design of the unified physical layer allows for the reuse of the existing service link technology, and extends the design of the service link to the feeder link and inter-satellite link. This can reduce the complexity of on-satellite payloads and further decrease their number.

For the service link-oriented MAC layer, the feeder link-oriented MAC layer and the inter-satellite link-oriented MAC layer, corresponding MAC layer protocols are respectively designed according to the characteristics and requirements of the service link, feeder link and inter-satellite link. For example, in a regenerative scenario, the service link is a link between a satellite-based base station and a terminal. The MAC layer protocol functions of the service link may include: providing the mapping of a logical link and a transmission link to the terminal, multiplexing and demultiplexing an MAC service data unit (SDU) in a transport block (TB), HARQ, scheduling (priority scheduling among different terminals, and priority scheduling among different logical channels in a same UE), etc. The feeder link is a link between a satellite and a gateway station. The main requirement for the feeder link is stable and reliable high-speed transmission. Therefore, the MAC layer protocol functions of the feeder link may include: multiplexing, demultiplexing, and HARQ functions. The feeder link may not have a scheduling function. The inter-satellite link is a link between satellites, which needs to ensure not only the reliability and stability of data transmission but also the fairness in data transmission between different inter-satellite links. Therefore, the MAC layer protocol functions of the inter-satellite link may include: multiplexing, demultiplexing, HARQ, and scheduling. In order to realize unified control of the service link, feeder link and inter-satellite link, the unified radio resource control (RRC) may be adopted, which includes: the configuration of the service link, feeder link and inter-satellite link, and the unified allocation of user identifiers for various terminals.

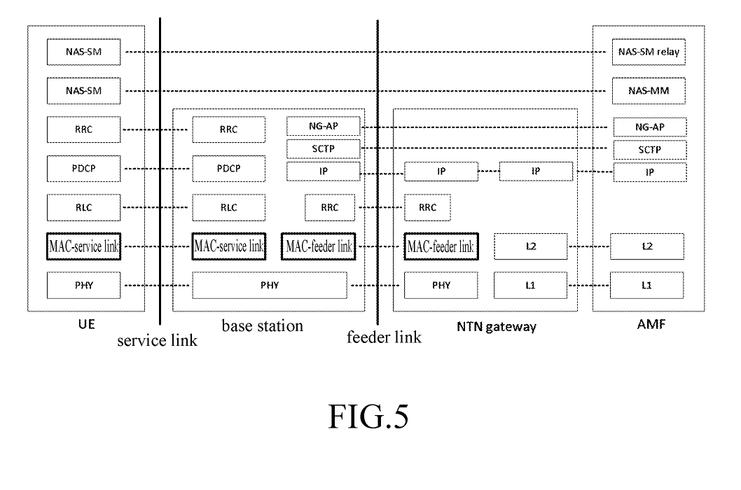

As shown in FIG. 4, it is a schematic diagram of a user plane protocol architecture of a regenerative architecture after an integrated design is adopted. As shown in FIG. 5, it is a schematic diagram of a signaling plane protocol architecture of a regenerative architecture after an integrated design is adopted. Specifically, as shown in FIG. 4, the user plane protocol architecture includes: a UE, a base station, an NTN gateway and an AMF, as well as the service link between the UE and the base station and the feeder link between the NTN gateway and the base station. The protocol stack above the UE are: PHY, MAC-service link, RLC, PDCP, SDAP and PDU; above the base station are: PHY, MAC-service link, RLC, PDCP, SDAP, MAC-feeder link, IP, UDP and GTP-U; above the NTN gateway are: PHY, MAC-feeder link, IP, L1, L2 and IP; and above the AMF are: L1, L2, IP, UDP, GTP-U and PDU. Specifically, as shown in FIG. 5, the signaling plane protocol architecture includes: UE, base station, NTN gateway and AMF, as well as the service link between the UE and the base station and the feeder link between the NTN gateway and the base station. Above the UE are: PHY, MAC-service link, RLC, PDCP, RRC, NAS-SM and NAS-SM; above the base station are: PHY, MAC-service link, RLC, PDCP, RRC, MAC-feeder link, RRC, IP, SCTP and NG-AP; above the NTN gateway are: PHY, MAC-feeder link, RRC, IP, L1, L2 and IP; above the AMF are: L1, L2, IP, SCTP, NG-AP, NG-AP, NAS-MM and NAS-SM relay. Specifically, the unification of the protocol layers is realized through the common physical layer and the radio resource control (RRC) layer, as well as the MAC layers designed for the feeder link and for the service link.

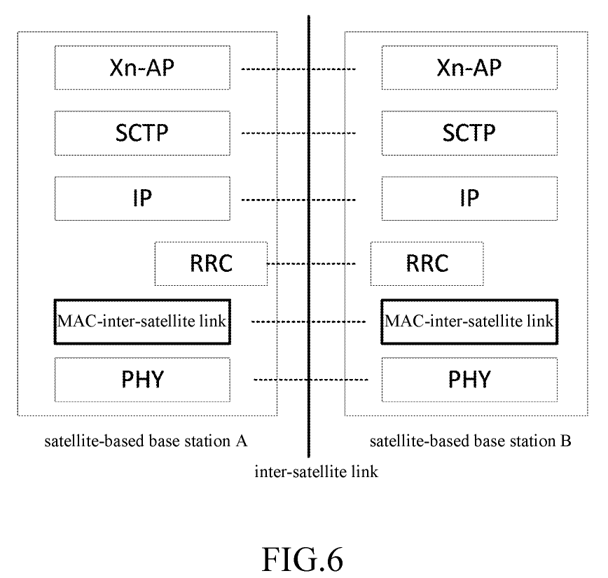

FIG. 6 shows a diagram of an inter-satellite link protocol architecture of a regenerative architecture after an integrated design is adopted, including: satellite-based base station A and satellite-based base station B, with an inter-satellite link established between them. The protocols on each of the satellite-based base stations include: PHY, MAC-inter-satellite link, RRC, IP, SCTP, and Xn-AP. The regenerative architecture protocols on the basis of integration can reduce the number of protocol stacks of the satellite-based base stations and unify the designs for the service link and the feeder link, thereby simplifying the on-satellite design. The radio resource control layer is used for the establishment, deletion, and configuration updating of the various links, different MAC layer functions are configured for different links, and unified user identifier allocation is carried out for the terminals of different links, and therefore, the unification of satellite-ground and inter-satellite interfaces based on a unified architecture is realized.

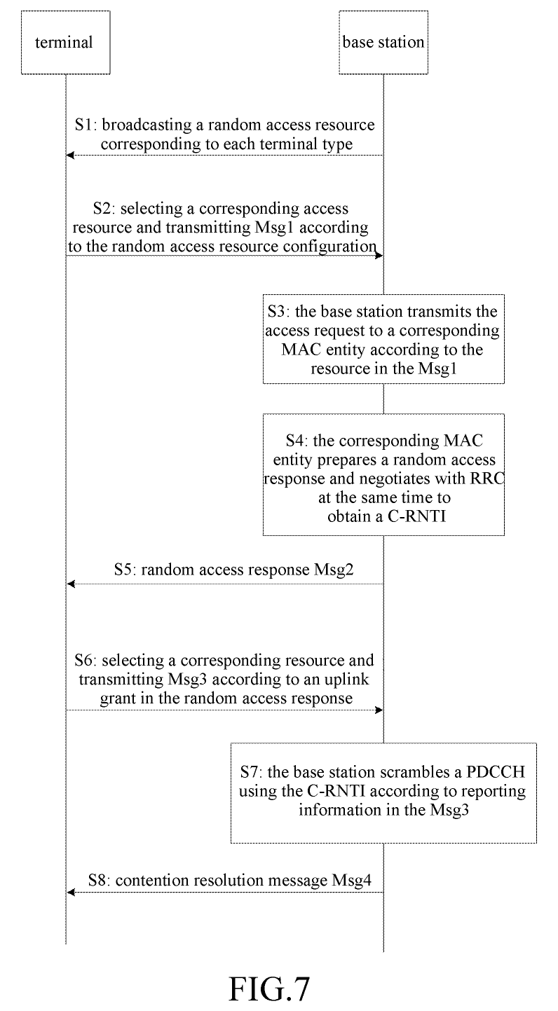

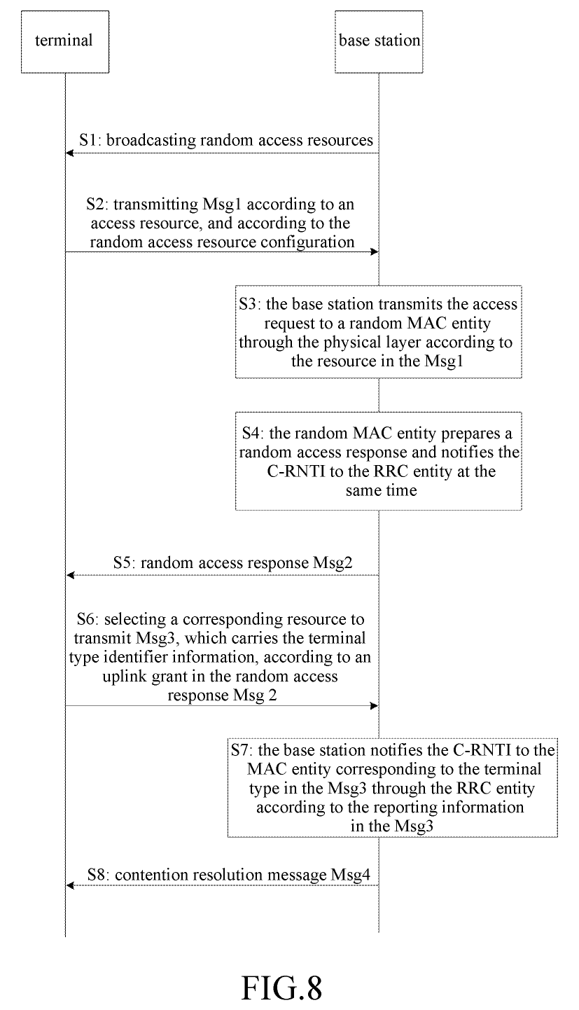

In this example, based on the design of the common physical layer, terminal access differs from the original service link access. The network needs to distinguish the type of the terminal. For example: the service link corresponds to a mobile phone terminal, the feeder link corresponds to a gateway station access terminal, and the inter-satellite link corresponds to a satellite access terminal. In order to further reduce the complexity in design and without introducing additional new link identifiers, the embodiments propose a method for distinguishing the service link, feeder link, and inter-satellite link using random access, which achieves an integrated space link access design by distinguishing different terminal types (such as traditional terminals like mobile phones, feeder link terminals like gateway stations, and inter-satellite link terminals like companion satellites) through random access and reporting the terminal types. By introducing specific information or messages for different terminal types, the physical layer determines the terminal types based on the specific information or messages and employs the unified random access procedure. The specific information here may be specific frequency and time resources. Different access types are distinguished by distinguishing the random access resources in different time and frequency domains, and different access types may also be distinguished by allowing the terminals to report the specific information under shared time and frequency resources:
1) Unified access procedure based on resource configuration may include: configuring different random access resources in the system information for different types of access terminals, so that the terminals can perform random access using the corresponding access resources according to their own types, and transmitting by the physical layer a corresponding access request to an MAC protocol entity for a corresponding link according to the random access resource where the received message is located, thereby realizing the access procedure for the link. Specifically, as shown in FIG. 7, it includes: S1: the base station establishes a correspondence between different types of access terminals and different random access resources via OAM configuration or pre-configuration, wherein the resources may be: resources in a time domain, a frequency domain, or a code domain; then, the base station transmits to the random access resource corresponding to a terminal to the terminal by broadcasting a system message. For example: traditional terminals such as mobile phones correspond to access resource 1, feeder link terminals such as gateway stations correspond to access resource 2, and inter-satellite link terminals such as companion satellites correspond to access resource 3. Specifically, the base station may broadcast to all terminals the random access resource corresponding to each terminal type. S2: the terminal selects a corresponding access resource and transmits Msg1 according to the random access resource configuration. For example, a gateway station terminal transmits message 1 (Msg1) on access resource 2. S3: since different types of access terminals correspond to different random access resources, after receiving the Msg1, the base station can determine the type of the terminal based on the random access resource, and then can send a random access request to the corresponding MAC entity, such as the MAC-feeder link. S4: the corresponding MAC entity, i.e., the MAC-feeder link, can prepare a random access response and negotiate with the unified RRC to obtain a C-RNTI (Cell-Radio Network Temporary Identifier); S5: the MAC entity (MAC-feeder link) of the base station responds to the random access request and transmits the random access response Msg2 to the terminal; S6: the terminal selects a corresponding resource and transmits Msg3 according to an uplink grant (UL resource grant) in the random access response; S7: after receiving the Msg3, the base station scrambles the PDCCH using the temporary C-RNTI according to the reporting information in the Msg3; S8: the base station transmits a contention resolution response to the UE, and the random access is completed.
2) The unified access procedure based on terminal's reporting of terminal types may include: reporting different access terminal types in Msg3 message during the random access process, and selecting by the base station side MAC protocol entities for the corresponding links for different terminals according to the types reported by the terminals, thereby realizing the access procedure for the links. Specifically, in the spatial link integration protocol design, for different terminal types, the Msg1 and Msg2 messages for random access can be completed according to the existing procedures, without distinguishing the corresponding MAC protocol stacks. Specifically, as shown in FIG. 8, it includes: S1: the base station broadcasts random access resources to terminals; S2: a certain terminal (e.g., a gateway station) initiates a random access request Msg1 to the base station; S3: the base station notifies the random access request to any MAC entity (e.g., MAC-service link) through a unified physical layer. This MAC entity is not necessarily the MAC entity corresponding to the terminal type, but may be any MAC entity serving as an intermediate MAC entity; S4: the intermediate MAC entity completes TA (Timing Advance) estimation, UL (Uplink) resource granting, and allocation of a C-RNTI (Cell-Radio Network Temporary Identifier), and the intermediate MAC entity notifies the temporary C-RNTI it allocated to a unified RRC layer; S5: the intermediate MAC entity responds to the random access request Msg1 and transmits a random access response Msg2 to the terminal; S6: the terminal selects a corresponding resource and transmits Msg3 according to an uplink grant (UL resource grant) in the random access response, wherein the Msg3 carries a terminal type identifier. The terminal type may be one of: a traditional terminal such as a mobile phone, a feeder link terminal such as a gateway station, or an inter-satellite link terminal such as a companion satellite, etc. The message transmitted as Msg3 may be RRC signaling, such as an RRC Setup Request message. The terminal type of the UE is identified by a newly added field named UE Type ID in this message, which is 2 bits in size. When the flag indicates "0", it represents a traditional terminal such as a terrestrial mobile phone; when the flag indicates "1", it represents a feeder link terminal such as a gateway station; when the flag indicates "2", it represents an inter-satellite link terminal such as a companion satellite; when the flag indicates "3", it represents spare. Alternatively, Msg3 may also be RRC signaling and an MAC CE, wherein the MAC CE is used to indicate the UE type identifier and specific information identifiers. S7: after receiving the Msg3, the base station performs admission control according to the terminal type identifier reported by the terminal in the Msg3. The base station, according to the reporting information in the Msg3, notifies the C-RNTI to the MAC entity corresponding to the terminal type in the Msg3 through an RRC entity. S8: the base station scrambles the PDCCH using the temporary C-RNTI and transmits it to the UE, and transmits a contention resolution response to the UE, and the random access is completed.

In the above embodiments, a link-integrated access method is proposed, which achieves unified access for the service link, satellite-ground link, and inter-satellite link. This provides, on one hand, a spatial integration protocol design function, including a unified physical layer, MAC layers for the service link, feeder link and inter-satellite link, and protocol layers above the MAC layers respectively corresponding to the service link, feeder link and inter-satellite link. In the spatial integrated access design, by introducing specific information or messages for different terminal types, the physical layer determines the terminal types through the specific information or messages, thereby using the unified random access procedures. The specific information may be: specific frequency and time resources. Different access types are distinguished by distinguishing the random access resources in different time and frequency domains, and different access types may also be distinguished by allowing the terminals to report the specific information under the shared time and frequency domains. That is, under the function of the unified physical layer, different protocol functions are designed for different links, and spatial link integration is achieved by adding link types. In this way, efficient task orchestration and resource utilization, as well as flexible satellite-ground and inter-satellite transmission can be achieved.

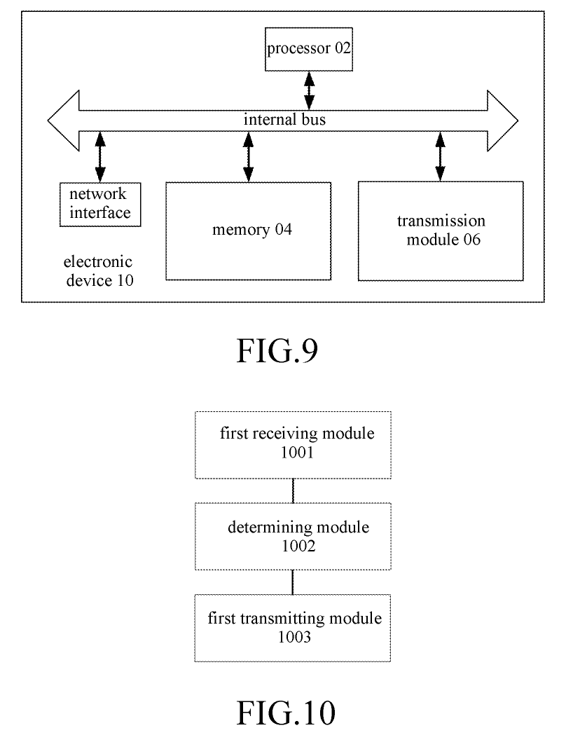

The method embodiments provided in the above embodiments of the present application can be executed in a mobile terminal, a computer terminal, or a similar computing device. The execution on an electronic device is taken as an example. FIG. 9 is a block diagram of a hardware structure of an electronic device for a link random access method as provided in the present application. As shown in FIG. 9, the electronic device 10 may include one or more (only one is shown in the figure) processors 02 (the processor 02 may include, but is not limited to a processing device such as a microprocessor MACU or a programmable logic device FPGA), a memory 04 for storing data, and a transmission module 06 for the communication function. Persons with ordinary skills in the art can understand that the structure shown in FIG. 9 is only illustrative and does not constitute any limitation on the structure of the electronic device. For example, the electronic device 10 may also include more or fewer components than those shown in FIG. 9, or may have a different configuration from that shown in FIG. 9.

The memory 04 can be used to store a software program and module of application software, such as the program instruction/module corresponding to the link random access method in the embodiments of the present application. The processor 02 executes various functional applications and data processing by running the software program and module stored in the memory 04, that is, it implements the link random access method of the application program. The memory 04 may include a high-speed random access memory, and may also include a non-volatile memory, such as one or more magnetic storage devices, flash memories, or other non-volatile solid-state memories. In some embodiments, the memory 04 may further include a memory provided remotely with respect to the processor 02. These remote memories can be connected to the electronic device 10 via a network. Examples of the network include, but are not limited to the Internet, an intranet, a local area network, a mobile communication network, and a combination thereof.

The transmission module 06 is used to receive or transmit data via a network. Specific examples of the network may include a wireless network provided by a communication provider of the electronic device 10. In one example, the transmission module 06 includes a network interface controller (NIC), which can be connected to other network devices through a base station to communicate with the Internet. In one example, the transmission module 06 may be a radio frequency (RF) module for communicating with the Internet in a wireless manner.

In an embodiment, the MAC entity may include, but is not limited to at least one of: a service link-oriented MAC layer, an inter-satellite link-oriented MAC layer, or a feeder link-oriented MAC layer.

In an embodiment, the terminal type to which the terminal belongs may include, but is not limited to at least one of: a user terminal, a satellite access terminal, or a gateway station access terminal.

In an embodiment, the above-described link random access device may further include: a broadcasting module configured to broadcast a system message to the at least one terminal, the system message indicating a correspondence between the terminal type and the random access resource; the determining module 1002 may specifically be configured for the unified physical layer to determine the terminal type to which the at least one terminal belongs according to the random access resource where the received random access request is located, and for the unified physical layer to determine a corresponding MAC entity according to the terminal type to which the at least one terminal belongs.

In an embodiment, the random access resource may include, but is not limited to at least one of: a time domain resource, a frequency domain resource, or a code domain resource.

In an embodiment, the determining module 1002 may specifically be configured for the unified physical layer to randomly select an MAC entity from one or more of the service link-oriented MAC layer, the inter-satellite link-oriented MAC layer, and the feeder link-oriented MAC layer as the determined MAC entity.

In an embodiment, the above-described link random access device may further include: a negotiating module configured for the determined MAC entity to negotiate with the unified RRC of the base station to obtain a cell radio network temporary identifier (C-RNTI) allocated for the at least one terminal.

In an embodiment, the above-described link random access device may further be used for the determined MAC entity to allocate the C-RNTI to the at least one terminal; to receive reporting information from the at least one terminal on an uplink granted resource, wherein the uplink granted resource is indicated by the random access response, and the reporting information carries a terminal type identifier of the at least one terminal; to determine an MAC entity corresponding to the terminal type as a target MAC entity according to the terminal type identifier; to notify the C-RNTI to the target MAC entity through a unified RRC layer; and after scrambling a PDCCH based on the C-RNTI, to transmit a contention resolution response to the at least one terminal.

In an embodiment, the reporting information may be RRC signaling, and the terminal type identifier is carried by newly adding an identifier field in the RRC signaling.

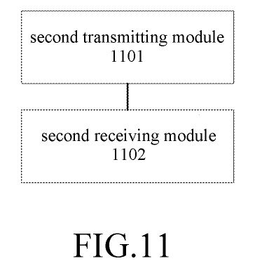

In this embodiment, also provided is a link random access device located in a terminal, which, as shown in FIG. 11, may include:
a second transmitting module 1101 configured to transmit a random access request to a base station on a random access resource corresponding to a terminal type to which the terminal belongs; and
a second receiving module 1102 communicating with the second transmitting module 1101 and configured to receive a random access response corresponding to the random access request transmitted from the base station, wherein the random access response carries an uplink grant.

In an embodiment, the MAC entity may include, but is not limited to at least one of: a service link-oriented MAC layer, an inter-satellite link-oriented MAC layer, or a feeder link-oriented MAC layer.

In an embodiment, the terminal type of the terminal side may include, but is not limited to at least one of: a user terminal, a satellite access terminal, or a gateway station access terminal.

In an embodiment, the link random access device may further be configured to select a resource according to the uplink grant and transmit the reporting information to the base station, wherein the reporting information carries a terminal type identifier of the terminal, wherein the terminal type identifier is used for the base station to determine an MAC entity.

The embodiments of the present application also provide a specific embodiment of an electronic device capable of implementing all the steps in the link random access method in the above embodiments. The electronic device specifically includes: a processor, a memory, a communication interface, and a bus; wherein the processor, the memory, and the communication interface complete mutual communications through the bus; the processor is used to call a computer program in the memory, and the processor implements all the steps in the link random access method in the above embodiments when executing the computer program. For example, when the processor executes the computer program, it implements the following steps:

Step 1: transmitting by a terminal a random access request to a base station on a random access resource corresponding to a terminal type to which the terminal belongs;

Step 2: receiving, on a unified physical layer of the base station, the random access request transmitted from the at least one terminal on the random access resource corresponding to the terminal type to which the at least one terminal belongs;

Step 3: determining, by the unified physical layer, an MAC entity and transmitting the random access request to the determined MAC entity;

Step 4: transmitting, to the at least one terminal, a random access response corresponding to the random access request, wherein the random access response is generated by the determined MAC entity;

Step 5: receiving, by the terminal, the random access response corresponding to the random access request transmitted from the base station, wherein the random access response carries an uplink grant.

The embodiments of the present application also provide a computer-readable storage medium capable of implementing all the steps in the link random access method in the above embodiments. The computer-readable storage medium has a computer program stored thereon. When the computer program is executed by a processor, all the steps in the link random access method in the above embodiments are implemented. For example, when the processor executes the computer program, it implements the following steps:

Step 1: transmitting, by a terminal, a random access request to a base station on a random access resource corresponding to a terminal type to which the terminal belongs;

Step 2: receiving, on a unified physical layer of the base station, the random access request transmitted from the at least one terminal on the random access resource corresponding to the terminal type to which the at least one terminal belongs;

Step 3: determining, by the unified physical layer, an MAC entity and transmitting the random access request to the determined MAC entity;

Step 4: transmitting, to the at least one terminal, a random access response corresponding to the random access request, wherein the random access response is generated by the determined MAC entity;

Step 5: receiving, by the terminal, the random access response corresponding to the random access request transmitted from the base station, wherein the random access response carries an uplink grant.

As can be seen from the above descriptions, in the embodiments of the present application, after a base station receives a random access request from a terminal, it notifies the random access request to the selected MAC entity through a unified physical layer to complete the link random access. That is, under the function of the unified physical layer, different MAC entities are designed for different links to achieve spatial link integration. In this way, the technical problem of the high demand for the number of payloads due to the different communication systems used for different links is solved, and the technical effect of realizing flexible satellite-ground transmission and inter-satellite transmission without increasing the number of payloads is achieved.

The embodiments of the present disclosure are all described in a progressive manner. Reference can be made to each other for the identical or similar parts of the embodiments. Each embodiment focuses on its differences from other embodiments. In particular, for hardware + program embodiments, since they are basically similar to the method embodiments, the descriptions of them are relatively simple, and reference can be made to the descriptions of the method embodiments for the relevant parts.

The foregoing describes the specific embodiments of the present disclosure. Other embodiments fall within the scope of the attached claims. In some cases, the actions or steps recorded in the claims may be executed in an order different from that in the embodiments but still achieve the desired result. In addition, the processes shown in the drawings do not necessarily indicate that the desired result can be achieved only by following the shown particular order or sequential order. In certain embodiments, multi-task processing and parallel processing are also possible or may be advantageous.

Although the present application provides method operation steps as described in the embodiments or flowcharts, more or fewer operation steps may be included based on conventional or non-creative efforts. The sequence of steps mentioned in the embodiments is merely one of a plurality of step execution sequences and does not represent a unique execution sequence. When the steps are executed by a system or device product in practice, they may be executed sequentially or in parallel in accordance with the method provided in the embodiments or in the drawings (for example, in a parallel processor or multi-thread processing environment).

Although the embodiments of the present application provides method operation steps as described in the embodiments or flowcharts, more or fewer operation steps may be included based on conventional or non-creative efforts. The sequence of steps mentioned in the embodiments is merely one of a plurality of step execution sequences and does not represent a unique execution sequence. When the steps are executed by a system or device product in practice, they may be executed sequentially or in parallel in accordance with the method provided in the embodiments or the drawings (for example, in a parallel processor or multi-thread processing environment, and even in a distributed data processing environment). The terms "comprise", "contain", or any other variations thereof are intended to cover a non-exclusive inclusion, such that a process, method, product, or device that includes a series of elements includes not only those elements, but also other elements that are not clearly listed or elements that are inherent to such process, method, product, or device. Without further limitation, it is not excluded that the process, method, product, or device that includes those elements still include other identical or equivalent elements.

For the convenience of description, when the above device is described, it is divided into various modules according to functions and the modules are respectively described. Obviously, when implementing the embodiments of the present disclosure, the functions of the modules may be implemented in the same one or more software and/or hardware, and the modules for realizing the same function may also be implemented by a combination of a plurality of sub-modules or sub-units. The device embodiments described above are merely illustrative. For example, the division of units is only a logical functional division. In actual implementation, there may be other division manners. For example, a plurality of units or components may be combined or integrated into another system, or some features may be omitted or not performed. In addition, the mutual coupling or direct coupling or communication connection shown or discussed may be indirect coupling or communication connection via some interfaces, devices, or units, and may be electrical, mechanical, or in other forms.

Persons skilled in the art also know that, in addition to implementing the controller by way of a pure computer-readable program code, it is entirely possible to enable the controller to achieve the same function in the form of a logic gate, a switch, an application-specific integrated circuit, a programmable logic controller, an embedded microcontroller, etc. by logically programming the method steps. Therefore, such a controller can be regarded as a hardware component, and the devices included therein for realizing the various functions may also be regarded as structures within the hardware component. Or even, the devices for realizing the various functions may be regarded as both software modules for implementing the method and structures within the hardware component.

The present application is described with reference to the flowcharts and/or block diagrams of the methods, devices (systems), and computer program products according to the embodiments of the present application. It should be understood that each procedure and/or block in the flowcharts and/or block diagrams, as well as the combinations of the procedures and/or blocks in the flowcharts and/or block diagrams, can be implemented by computer program instructions. These computer program instructions may be provided to a processor of a general-purpose computer, a special-purpose computer, an embedded processing machine, or other programmable data processing devices to produce a machine, such that the instructions executed by the processor of the computer or other programmable data processing devices produce devices for implementing the functions specified in one or more procedures in the flowcharts and/or one or more blocks in the block diagrams.

Persons skilled in the art shall understand that the embodiments of the present disclosure may be provided as a method, system, or computer program product. Therefore, the embodiments of the present disclosure may take the form of a complete hardware embodiment, a complete software embodiment, or an embodiment combining both software and hardware aspects. Furthermore, the embodiments of the present disclosure may take the form of a computer program product implemented on one or more computer-usable storage media (including but not limited to a disk storage, a CD-ROM, an optical storage, etc.) that contains a computer-usable program code.

The embodiments of the present disclosure may be described in the general context of the computer-executable instructions executed by a computer, such as program modules. In general, the program modules include routines, programs, objects, components, data structures, etc., that perform particular tasks or implement particular abstract data types. The embodiments of the present disclosure may also be practiced in a distributed computing environment where tasks are performed by remote processing devices that are connected via a communication network. In the distributed computing environment, the program modules may be located in both local storage media and remote computer storage media, including storage devices.

The embodiments of the present disclosure are described in a progressive manner. Reference can be made to each other for the identical or similar parts of the embodiments. Each embodiment focuses its differences from other embodiments. In particular, for system embodiments, since they are basically similar to the method embodiments, the descriptions of them are relatively simple, and reference can be made to the descriptions of the method embodiments for the relevant parts. In the descriptions of the specification, the terms "one embodiment", "some embodiments", "example", "specific example", or "some examples", etc., mean that the specific features, structures, materials, or characteristics described in the embodiments or examples are included in at least one embodiment or example of the embodiments of the present disclosure. In the specification, schematic expressions of the above terms do not necessarily refer to the same embodiment or example. Furthermore, the described specific features, structures, materials, or characteristics can be combined in an appropriate manner in any one or more embodiments or examples. In addition, in the case where there is not mutual contradiction, persons skilled in the art can join and combine the different embodiments or examples and the features of different embodiments or examples described in the specification.

The foregoing are merely examples of the embodiments of the present disclosure and are not intended to limit the embodiments of the present disclosure. Persons skilled in the art can make various modifications and variations to the embodiments of the present disclosure. Any modifications, equivalent replacements, improvements, etc., made within the spirit and principle of the embodiments of the present disclosure shall fall within the scope of the claims of the embodiments of the present disclosure.

1. A link random access method, applied to a terminal, comprising:
transmitting a random access request to a base station on a random access resource corresponding to a terminal type to which the terminal belongs; and
receiving a random access response corresponding to the random access request transmitted from the base station, wherein the random access response carries an uplink grant.

2. The method according to claim 1, wherein the terminal type comprises at least one of: a user terminal, a satellite access terminal, or a gateway station access terminal.

3. The method according to claim 1, further comprising selecting a resource according to the uplink grant to transmit reporting information to the base station, wherein the reporting information carries a terminal type identifier of the terminal, and wherein the terminal type identifier is used for the base station to determine an MAC entity.

4. A base station device, comprising a processor and a memory for storing instructions executable by the processor, wherein the processor, when executing the instructions, implements a method comprising:
receiving, on a unified physical layer of the base station, a random access request transmitted from at least one terminal on a random access resource corresponding to a terminal type to which the at least one terminal belongs;
determining, by the unified physical layer, an MAC entity and transmitting the random access request to the determined MAC entity; and
transmitting, to the at least one terminal, a random access response corresponding to the random access request, wherein the random access response is generated by the determined MAC entity.

5. The base station device according to claim 4, wherein the MAC entity comprises at least one of a service link-oriented MAC layer, an inter-satellite link-oriented MAC layer, or a feeder link-oriented MAC layer.

6. The base station device according to claim 5, wherein the method implemented by the processor further comprises:
broadcasting, to the at least one terminal, a system message indicating a correspondence between the terminal type and the random access resource;
wherein the determining of the MAC entity comprises:
determining, by the unified physical layer, a terminal type to which the at least one terminal belongs according to the random access resource where the received random access request is located; and
determining, by the unified physical layer, a corresponding MAC entity according to the terminal type to which the at least one terminal belongs.

7. The base station device according to claim 6, wherein the method implemented by the processor further comprises:
negotiating, by the determined MAC entity, with a unified RRC of the base station to obtain a cell-radio network temporary identifier allocated for the at least one terminal.

8. The base station device according to claim 5, wherein the determining of the MAC entity comprises:
randomly selecting, by the unified physical layer, an MAC entity from one or more of the service link-oriented MAC layer, the inter-satellite link-oriented MAC layer, or the feeder link-oriented MAC layer as the determined MAC entity.

9. The base station device according to claim 8, wherein the method implemented by the processor further comprises:
allocating, by the determined MAC entity, a cell-radio network temporary identifier for the at least one terminal;
receiving, on an uplink granted resource, reporting information from the at least one terminal, wherein the uplink granted resource is indicated by the random access response, and the reporting information carries a terminal type identifier of the at least one terminal;
determining, according to the terminal type identifier, an MAC entity corresponding to the terminal type as a target MAC entity;
notifying, by a unified RRC layer, the cell-radio network temporary identifier to the target MAC entity; and
transmitting, to the at least one terminal, a contention resolution response after scrambling a PDCCH based on the cell-radio network temporary identifier.

10. The base station device according to claim 9, wherein the reporting information is RRC signaling, and the terminal type identifier is carried by an identifier field newly added in the RRC signaling.

11. The base station device according to claim 4, wherein the terminal type to which the terminal belongs comprises at least one of a user terminal, a satellite access terminal, or a gateway station access terminal.

12. The base station device according to claim 4, wherein the random access resource comprises at least one of a time domain resource, a frequency domain resource, or a code domain resource.

13. A terminal device, comprising a processor and a memory for storing instructions executable by the processor, wherein the processor, when executing the instructions, implements a method comprising:
transmitting a random access request to a base station on a random access resource corresponding to a terminal type to which the terminal belongs; and
receiving a random access response corresponding to the random access request transmitted from the base station, wherein the random access response carries an uplink grant.

14. The terminal device according to claim 13, wherein the terminal type comprises at least one of a user terminal, a satellite access terminal, or a gateway station access terminal.

15. The terminal device according to claim 13, wherein the method implemented by the processor further comprises:
selecting a resource according to the uplink grant to transmit reporting information to the base station, wherein the reporting information carries a terminal type identifier of the terminal, and wherein the terminal type identifier is used for the base station to determine an MAC entity.
